(19) United States
(12) Patent Application Publication
(10) Pub. No.: US 2016/0092032 A1
(43) Pub. Date: Mar. 31, 2016

(54) OPTICAL TOUCH SCREEN SYSTEM AND COMPUTING METHOD THEREOF

(71) Applicant: Pixart Imaging Inc., Hsin-Chu (TW)

(72) Inventors: Tzung Min SU, Hsinchu (TW); Cheng Nan TSAI, Hsinchu (TW); Chih Hsin LIN, Hsinchu (TW)

(73) Assignee: Pixart Imaging Inc.

(21) Appl. No.: 14/963,382

(22) Filed: Dec. 9, 2015

Related U.S. Application Data
(63) Continuation of application No. 13/302,481, filed on Nov. 22, 2011.

(30) Foreign Application Priority Data
Nov. 22, 2010 (TW) 099140132

(51) Int. Cl. G06F 3/042

(52) U.S. Cl. CPC G06F 3/0421

(57) ABSTRACT

An optical touch screen system includes a sensing device and a processing unit. The sensing device includes first and second sensors, each generating an image. The images include the image information of a plurality of objects. The processing unit generates a plurality of candidate coordinates according to the image information and selects a portion of the candidate coordinates as output coordinates according to an optical feature of the image information.

### CROSS-REFERENCE TO RELATED APPLICATION

The present application is a Continuation application of U.S. patent application Ser. No. 13/302,481, filed Nov. 22, 2011 which claims the priority of the Taiwan Patent Application Serial Number 099140132, filed on Nov. 22, 2010, the disclosure of which is hereby incorporated by reference herein in its entirety.

### BACKGROUND OF THE INVENTION

1. Field of the Invention

The present invention relates to a touch system, and relates more particularly to a touch system that can correctly determine object coordinate pairs according to the optical feature of image information or mirror image information.

2. Description of the Related Art

Touch screen devices, a presently popular input means of computer systems, allow users to input commands via direct contact with screens. Users can utilize styluses, finger points or the like to touch screens. Touch screen devices detect and compute touch locations, and output coordinates to computer systems to perform sequential operations. As yet, there have been many applicable touch technologies including resistive, capacitive, infrared, surface acoustic wave, magnetic, and near field imaging.

Single touch technologies for detecting a touch event generated by a finger or a stylus and computing touch coordinates have been extensively applied to many electronic devices. In addition, multi-touch technologies for detecting or identifying a second touch event or a so-called gesture event are being increasingly adopted. The touch screen devices capable of detecting multi-touch points allow users to simultaneously move plural fingers on screens to generate a moving pattern that can be transformed by control devices into a corresponding input command. For instance, a common moving pattern is a motion in which a user pinches two fingers on a picture to reduce the picture.

The multi-touch technologies developed based on single touch technologies face many difficulties in determining the accurate coordinates of simultaneously existing touch points. As an example, in optical touch screen devices, controllers may compute two coordinate pairs according to obtained images, but cannot directly compute the real coordinates of two finger points. Thus, the conventional optical touch screen devices cannot easily compute the coordinates of touch points.

### SUMMARY OF THE INVENTION

One embodiment of the present invention provides an optical touch screen system comprising a sensing device and a processing unit. The sensing device may comprise first and second sensors. Each of the first and second sensors may generate an image. The image may comprise the image information of a plurality of objects. The processing unit may be configured to generate a plurality of candidate coordinates according to the image information and select a portion of the plurality of candidate coordinates as output coordinates according to an optical feature of the image information.

Another embodiment of the present invention proposes an optical touch screen system comprising a sensing device and a processing unit. The sensing device may comprise a mirror member and a sensor configured to generate an image. The image may comprise image information generated by a plurality of objects and mirror image information generated by reflection from the plurality of objects through the mirror member. The processing unit may be configured to generate a plurality of candidate coordinates according to the image information and the mirror image information of the objects, and may be configured to determine a portion of the plurality of candidate coordinates as output coordinates according to an optical feature of the image information and an optical feature of the mirror image information for outputting.

One embodiment of the present invention discloses a computing method of an optical touch screen system. The method may comprise detecting a plurality of objects using a sensing device, calculating a plurality of candidate coordinates according to a detecting result of the sensing device, and selecting a portion of the plurality of candidate coordinates as output coordinates for outputting according to an optical feature of each object detected by the sensing device.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 is a view showing an optical touch screen system according to one embodiment of the present invention;

FIG. 2 is a view showing an image generated by a sensor according to one embodiment of the present invention;

FIG. 3 demonstrates a method of calculating the coordinates of objects;

FIG. 4 is a view showing an optical touch screen system according to another embodiment of the present invention;

FIG. 5 is a view showing an image generated by a first sensor according to one embodiment of the present invention;

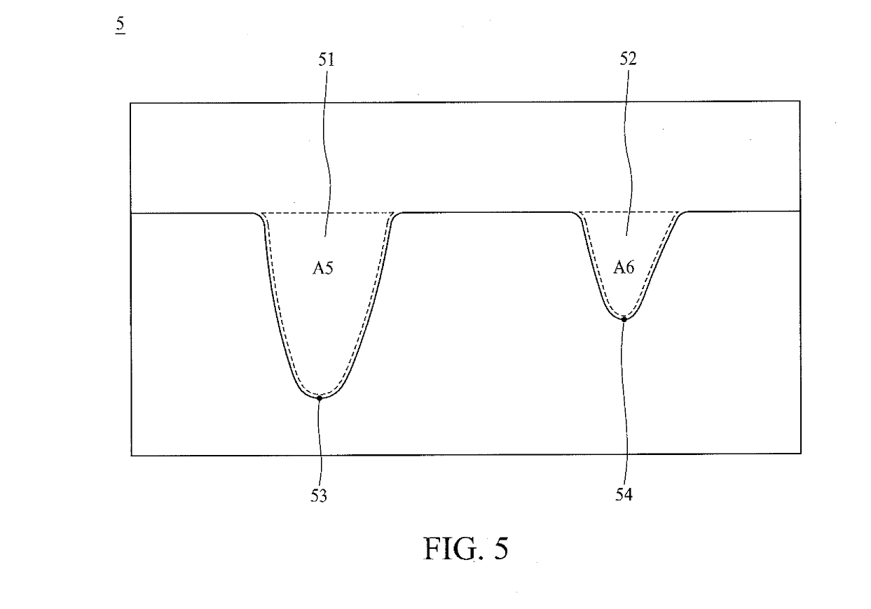

FIG. 6 is a view showing an image generated by a second sensor according to one embodiment of the present invention;

FIG. 7 is a view demonstrating coordinate calculation of objects according to one embodiment of the present invention; and

FIG. 8 is a view demonstrating viewing lines and candidate coordinate pairs of objects according to one embodiment of the present invention.

### DETAILED DESCRIPTION OF THE INVENTION

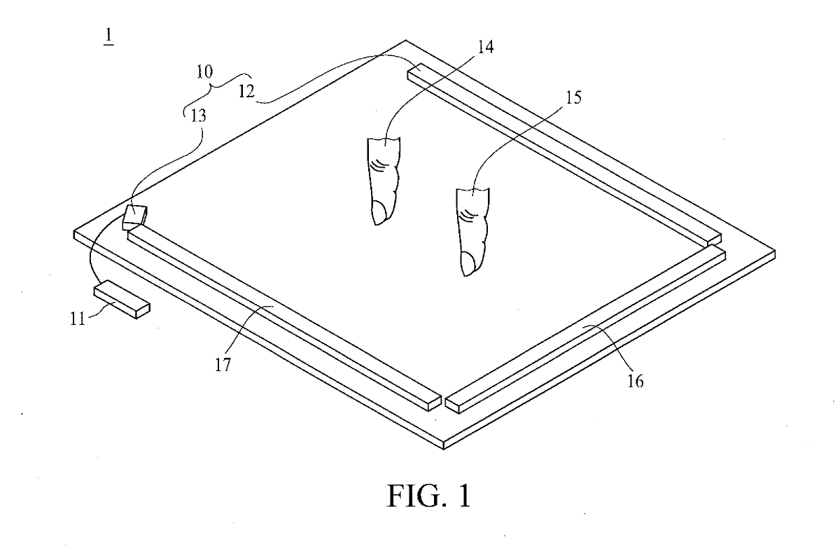

FIG. 1 is a view showing an optical touch screen system 1 according to one embodiment of the present invention. The optical touch screen system 1 may be a multi-touch screen system and can select a correct coordinate pair from plural computed coordinates of objects 14 and 15 utilizing an optical feature of the objects 14 and 15 on an image. The optical touch screen system 1 may comprise a sensing device 10 and a processing unit 11 coupled to the sensing device 10. The sensing device 10 is configured to provide images for the analysis of the coordinates of objects 14 and 15. The processing unit 11 is configured to calculate the coordinates of the objects 14 and 15 according to the images generated by the sensing device 10.

In one embodiment, the sensing device 10 may comprise a mirror member 12 and a sensor 13. The mirror member 12 can define a sensing region together with two elongated members 16 and 17, which can be light-emitting members or light reflective members. The mirror member 12 may comprise a mirror surface configured to face toward the sensing region so as to produce mirror images of the objects 14 and 15 when the objects 14 and 15 are in the sensing region. The sensor 13 may be disposed adjacent to one end of the elongated member 17 opposite to the mirror member 12 with its sensing surface facing the sensing region.

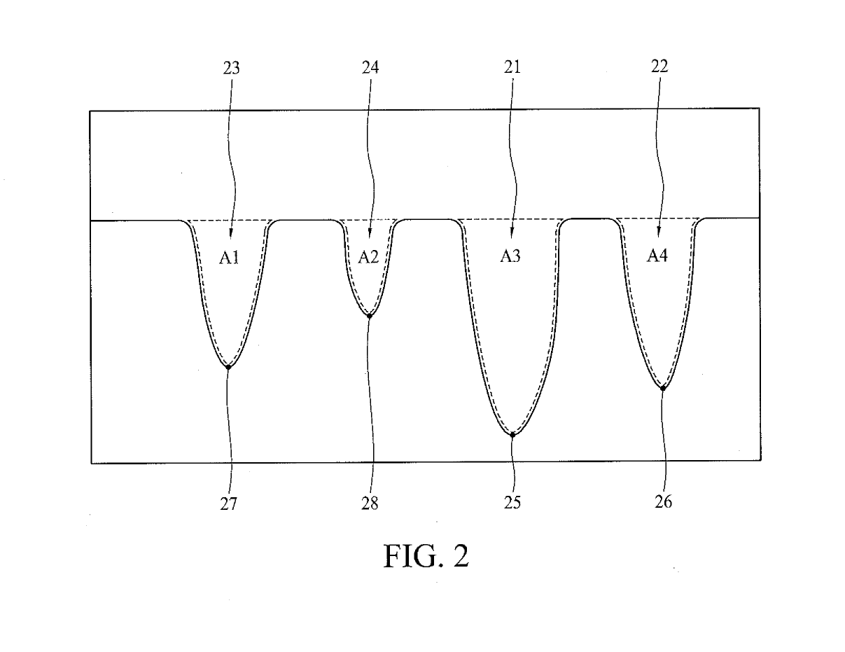

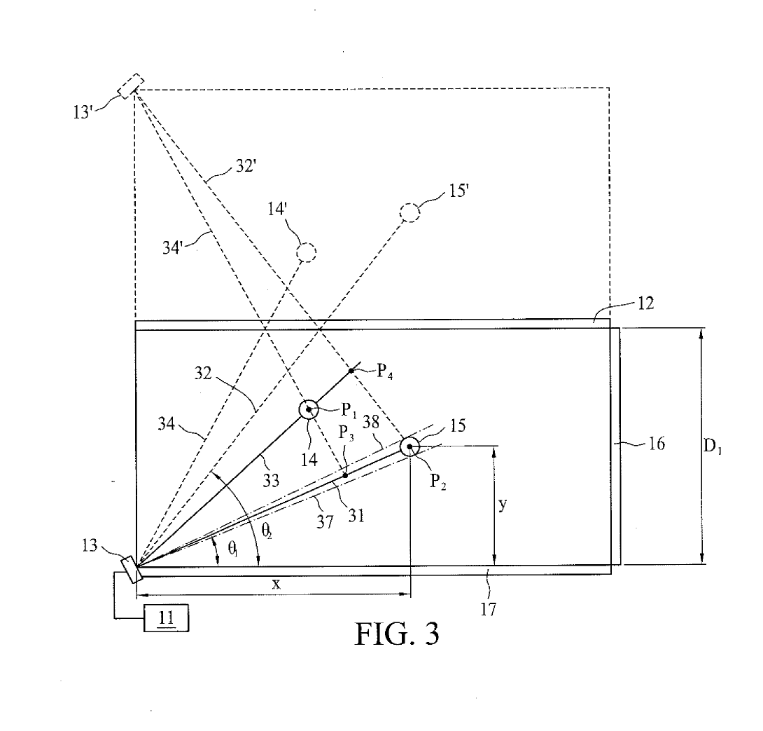

FIG. 2 is a view showing an image 2 generated by the sensor 13 according to one embodiment of the present invention. FIG. 3 demonstrates a method of calculating the coordinates of objects 14 and 15. Referring to FIGS. 1 to 3, as the objects simultaneously enter the sensing region, the mirror member 12 may respectively form the virtual images 14′ and 15′ of the objects 14 and 15. At the same time, the objects 14 and 15 and the virtual images 14′ and 15′ thereof create the distribution of light and shade on the sensing surface of the sensor 13. At such moment, the sensor 13 can generate an image 2 having a distribution of light and shade, wherein the image 2 may comprise image information 21 formed by the object 14, image information 22 formed by the object 15, mirror image information 23 formed by the virtual image 14′ of the object 14, and mirror image information 24 formed by the virtual image 15′ of the object 15.

In one embodiment, the optical touch screen system 1 can be configured to allow the objects 14 and 15 to block the light incident toward the sensor 13 so that dark image information having an intensity level lower than that of the background of the image 2 can be produced by the sensor 13. In such optical touch screen system 1, the intensity level of the mirror image information generated by the virtual images 14′ and 15′ of the object 14 and 15 may also be lower than that of the background of the image 2.

In another embodiment, the optical touch screen system 1 is configured to project light onto the objects 14 and 15, allowing the objects 14 and 15 to reflect the light incident on the objects 14 and 15 to the sensor 13 so that the objects 14 and 15 can generate, on the image 2, reflective information having an intensity level higher than that of the background of the image 2.

Referring to FIG. 3, regarding the calculation of the coordinate pair P₁ and P₂ of the objects 14 and 15, the object 15 is utilized as an example for demonstration. The same calculating procedures can be applied to the object 14. After the sensor 13 generates the image 2, the processing unit 11 may determine the viewing line 31 extending through the object 15 from the position of the sensor 13 used as a starting point, according to the image information 22 generated by the object 15 in the image 2. Next, the processing unit 11 may compute the included angle θ₁ between the viewing line 31 and the elongated member 17. Similarly, the processing unit 11 can determine the viewing line 32 extending toward the virtual image 15′ from the position of the sensor 13 used as a starting point, according to the mirror image information 24 generated by the virtual image 15′ of the object 15 in the image 2, and the processing unit 11 can compute the included angle θ₂ between the viewing line 32 and the elongated member 17. Finally, the processing unit 11 may compute the coordinate P₂(x, y) of the object 15 according to the following equations (1) and (2):

$$\begin{matrix}x = \frac{2 \times {D}_{1}}{( tan {θ}_{1} + tan {θ}_{2} )} & ( 1 ) \\ y = x \times tan {θ}_{1} & ( 2 )\end{matrix}$$

Where D₁ is the distance between the mirror member 12 and the elongated member 17.

Although the sensing region of the optical touch screen system 1 in the present embodiment is rectangular, the present invention is not limited to such an arrangement. Regarding the calculation of the coordinates of the objects 14 and 15 in the present embodiment, reference can be made to Taiwan Patent Publication No. 201003477 or its U.S. Patent Application Publication No. 2010094586, and to Taiwan Patent Publication No. 201030581 or its counterpart U.S. Patent Application Publication No. 2010094584, for details.

Regarding the method for finding the viewing lines 31 and 32, if the viewing line 31 is taken as an example, two viewing lines 37 and 38 touching two side edges of the object 15 are respectively computed, and an average of the two viewing lines 31 and 32 is calculated. For more details, refer to U.S. Pat. No. 4,782,328.

Referring to FIGS. 2 and 3, normally, when the processing unit 11 computes the coordinates of the objects 14 and 15, the processing unit 11 may have no way of determining the corresponding relationships between the image information 21 and 22 and the mirror image information 23 and 24, and needs to first determine the coordinate pair P₁ and P₂ of the objects 14 and 15. Thus, the processing unit 11 may calculate a plurality of candidate coordinates P₁, P₂, P₃ and P₄ according to all possible combinations of the image information 21 and 22 and the mirror image information 23 and 24. The plurality of candidate coordinates P₁, P₂, P₃ and P₄ are the intersection points of the viewing lines 31, 32, 33, and 34. The viewing lines 31, 32, 33, and 34 may be considered as imaginary lines, on which lie possible locations of the objects 14 and 15 and the virtual images 14′ and 15′ forming the image information 21 and 22 and the mirror image information 23 and 24. Because the mirror member 12 reflects light, the viewing lines 32 and 34 change its extending direction in a manner similar to the reflection of light when the viewing lines 32 and 34 extend to the mirror surface of the mirror member 12.

When the object 14 or 15 moves closer to the sensor 13, the area A3 or A4 of the image information 21 and 22 may become larger, and if the image information 21 or 22 is dark image information, the lowest intensity level 25 or 26 of the image information 21 or 22 may be lower. If light is cast on the objects 14 or 15, which reflect incident light to the sensor 13, the image information 21 or 22 is reflective information. Under such a circumstance, the highest intensity level of the image information 21 or 22 may be higher when the object 14 or 15 moves closer to the sensor 13. Due to such an observation, if the above-mentioned optical features of the image information 21 or 22 of the image 2 are applied, the actual coordinate pair P₁ and P₂ of the objects 14 and 15 can be correctly determined. Referring to FIGS. 2 and 3, after the candidate coordinates P₁, P₂, P₃ and P₄ are calculated, the processing unit 11 may select correct coordinate pair P₁ and P₂ of the objects 14 and 15 according to the optical feature of the image information 21 or 22 of the objects 14 and 15 and the optical feature of the mirror image information 23 and 24 of the virtual images 14′ and 15′, wherein the optical feature may comprise the size of the area A1, A2, A3, or A4 of the image information 21 or 22 or the mirror image information 23 or 24. Alternatively, the optical feature may comprise the lowest intensity level 25, 26, 27 or 28 of the image information 21 or 22 or the mirror image information 23 or 24.

In one embodiment, the processing unit 11 may compare the area A3 of the image information 21 and the area A4 of the image information 22. If the comparison finds that the area A3 of the image information 21 is larger than the area A4 of the image information 22, the processing unit 11 will determine that the object 14 on the viewing line 33 is closer to the sensor 13 than the object 15 on the viewing line 31. As a result, the processing unit 11 may select the coordinate P₁, the coordinate closer to the sensor 13 on the viewing line 33 according to the comparison result, and select the coordinates P₂, which is farther from the sensor 14 on the viewing line 34. Similarly, the processing unit 11 may compare the areas A1 and A2 of the mirror image information 23 and 24, determine which of the virtual images 14′ and 15′ is closer to the sensor 13, and select the correct coordinate pair.

In another embodiment, the processing unit 11 may compare the lowest intensity level 25 of the image information 21 with the lowest intensity level 26 of the image information 22. If the comparison finds that the lowest intensity level 25 of the image information 21 is lower than the lowest intensity level 26 of the image information 22, the processing unit 11 will conclude that the object 14 on the viewing line 33 is closer to the sensor 13 than the object 15 on the viewing line 31. Finally, the processing unit 11 can select the coordinate P₁ that is closer to the sensor 13 on the viewing line 33, and select the coordinate P₂ that is farther from the sensor 13 on the viewing line 31. The processing unit 11 may also compare the lowest intensity levels of the mirror image information 27 and 28 to select the correct output coordinate pair P₁ and P₂ using similar determination procedures.

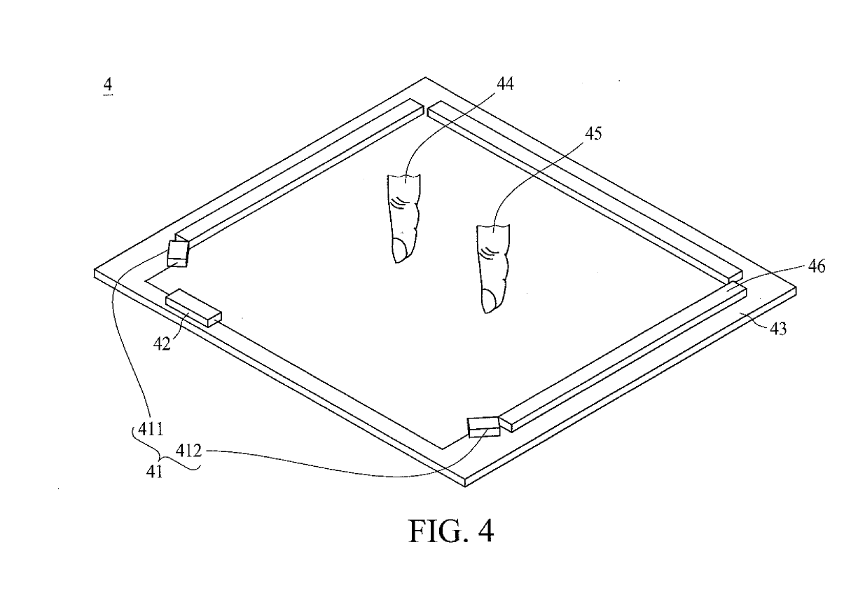

FIG. 4 is a view showing an optical touch screen system 4 according to another embodiment of the present invention. Referring to FIG. 4, the optical touch screen system 4 of another embodiment of the present invention may comprise a sensing device 41 and a processing unit 42 coupled to the sensing device. The sensing device 41 may comprise a first sensor 411 and a second sensor 412, which are separately disposed adjacent to two adjacent corners of a sensing region defined by elongated members 46 on a substrate 43. In one embodiment, at least a part of the elongated member 46 is a light reflective member. In another embodiment, at least a part of the elongated member 46 is a light-emitting member.

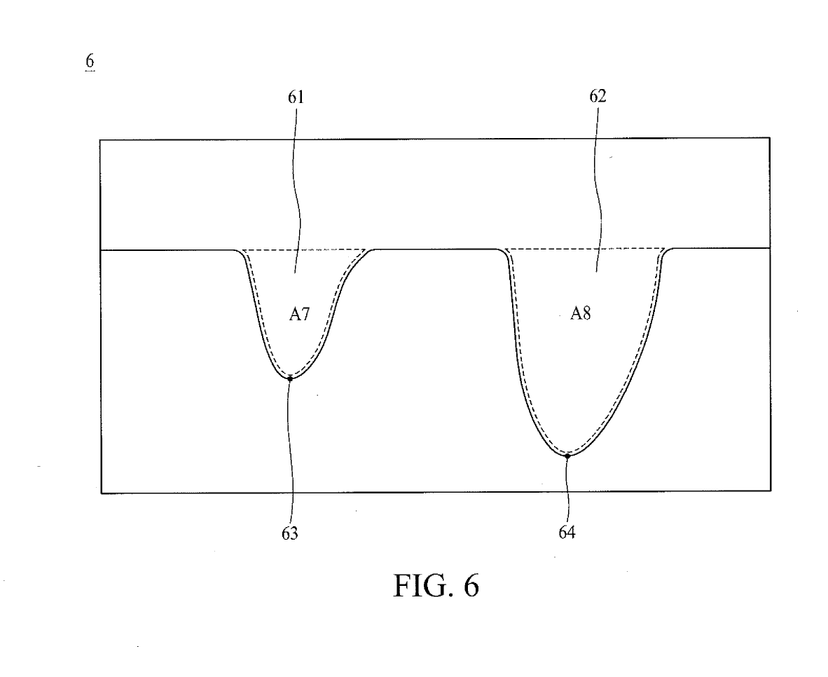

Referring to FIGS. 4 and 6, when two objects 44 and 45 contact the substrate 43, the objects 44 and 45 create a distribution of light and shade on the sensing surfaces of the first and second sensors 411 and 412. Under such a circumstance, the first sensor 411 may generate an image 5 comprising image information 51 and 52 produced by the objects 44 and 45. Similarly, the second sensor 412 may generate an image 6 comprising image information 61 and 62 produced by the objects 44 and 45.

In one embodiment, the optical touch screen system 4 can be configured to allow the objects 44 and 45 to block the light incident toward the first and second sensors 411 and 412 so that image information 51, 52, 61, and 62 having an intensity level lower than that of the background of the images 5 and 6 can be generated by the first and second sensor 411 or 412.

In another embodiment, the optical touch screen system 4 can be configured to allow the first and second sensors 411 and 412 to receive the light reflected from the objects 44 and 45, and consequently, the objects 44 and 45 can generate image information 51, 52, 61, and 62, on the images 5 and 6, having an intensity level higher than that of the background of the images 5 and 6.

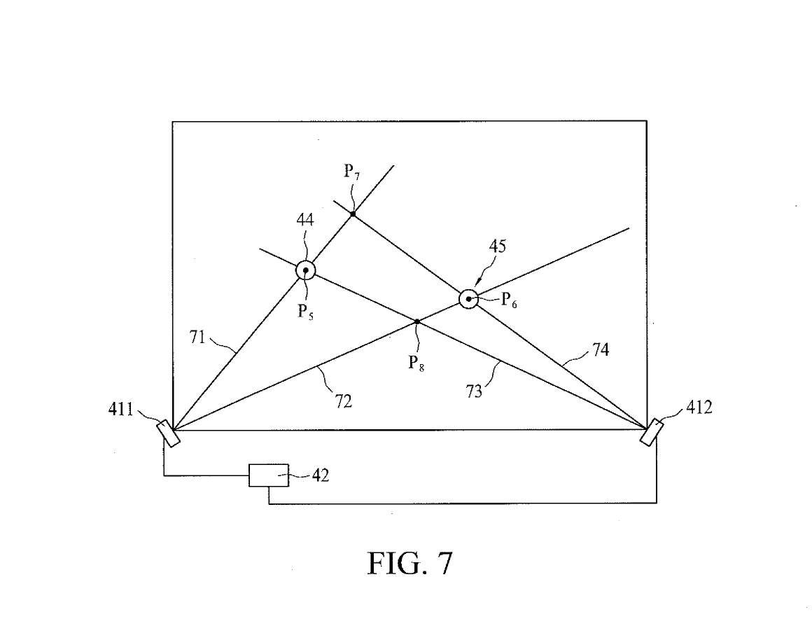

As shown in FIG. 7, the processing unit 42 may determine viewing lines 71 and 72 extending from the first sensor 411 as an starting point according to the image information 51 and 52 of the image 5 generated by the first sensor 411. For more details on determining the viewing lines 71 and 72, refer to U.S. Pat. No. 4,782,328. The processing unit 42 may further determine viewing lines 73 and 74 extending from the second sensor 412 as an starting point according to the image information 61 and 62 of the image 6 generated by the second sensor 412. Next, the processing unit 42 can calculate a plurality of candidate coordinates P₅, P₆, P₇ and P₈ using the plurality of viewing lines 71, 72, 73, and 74. Finally, the processing unit 42 selects output coordinate pair P₅ and P₆ by comparing the optical features of the image information 51 and 52 or those of the image information 61 and 62.

In one embodiment, after making the comparison, the processing unit 42 selects and outputs the coordinate P₅ which is closer to the first sensor 411 on the viewing line 71 because the area A5 of the image information 51 is larger than the area A6 of the image information 52, and selects and outputs the coordinate P₆ which is farther from the first sensor 411 on the viewing line 72. Alternatively, the processing unit 42 compares the image information 61 with the image information 62, the processing unit 42 selects and outputs the coordinate P₅ which is farther from the second sensor 412 on the viewing line 73 because the area A8 of the image information 62 is larger than the area A7 of the image information 61, and the processing unit 42 selects and outputs the coordinate P₆ which is closer to the second sensor 411 on the viewing line 74.

In another embodiment, the processing unit 42 may compare the lowest intensity level 53 of the image information 51 with the lowest intensity level 54 of the image information 52. If the comparison determines that the object 44 producing the image information 51 is closer to the first sensor 411 than the object 45 producing the image information 52, the processing unit 42 selects and outputs the coordinate P₅, which is closer to the first sensor 411 on the viewing line 71, and selects and outputs the coordinate P₆, which is farther from the first sensor 411 on the viewing line 72. Alternatively, the processing unit 42 may choose to compare the lowest intensity levels 63 and 64 of the image information 61 and 62 to select and output the coordinate pair P₅ and P₆.

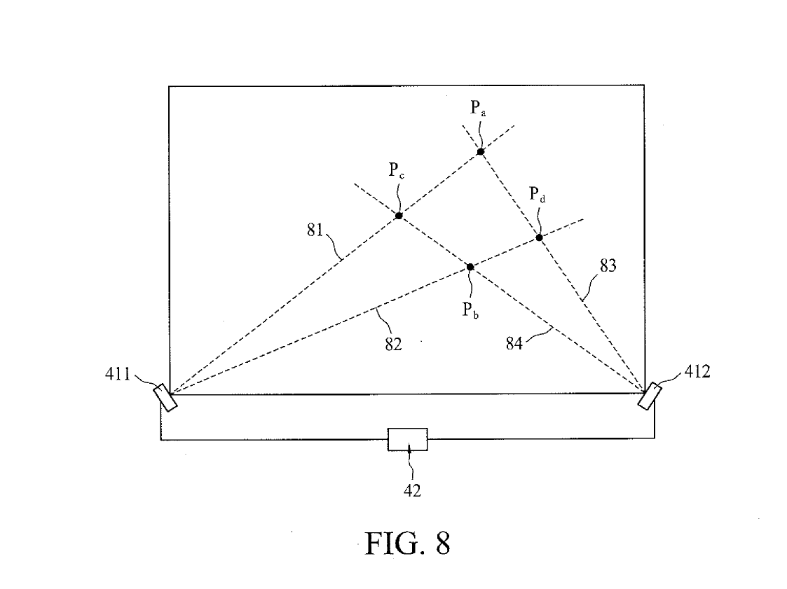

Referring to FIGS. 4 and 8, in one embodiment, the coordinates of the objects 44 and 45 on the substrate 43 can be calculated based on the areas A11 and A12 of a plurality of image information generated by the objects 44 and 45 through the first sensor 411, and the areas A21 and A22 of a plurality of image information generated by the objects 44 and 45 through the second sensor 412, wherein the image information may be dark image information or reflective information.

The processing unit 42 may calculate a plurality of candidate coordinates Pₐ, P_{b}, P_{c} and P_{d} according to viewing lines 81, 82, 83, and 84 determined by image information obtained using the first and second sensors 411 and 412. The actual coordinates of the objects 44 and 45 can be determined using any of the equations in Table 1 below,

TABLE 1

| Equation | Selected coordinate pair |
|---|---|
| A11 < A12 and A21 > A22 | (Pₐ, P_{b}) |
| A11 > A12 and A21 < A22 | (P_{c}, P_{d}) |
| A11 < A12 and A21 = A22 | (Pₐ, P_{b}) |
| A11 = A12 and A21 > A22 | (Pₐ, P_{b}) |
| A11 > A12 and A21 = A22 | (P_{c}, P_{d}) |
| A11 = A12 and A21 < A22 | (P_{c}, P_{d}) |

In another embodiment, the coordinates of the objects 44 and 45 on the substrate 43 can be calculated based on the lowest intensity levels I11 and I12 of a plurality of image information (if the image information is dark image information) or the highest intensity levels I11 and I12 of a plurality of image information (if the image information is reflective information) generated by the objects 44 and 45 through the first sensor 411 and on the lowest or highest intensity levels I21 and I22 of a plurality of image information generated by the objects 44 and 45 through the second sensor 412 so as to select correct coordinates of the objects 44 and 45. The actual coordinates of the objects 44 and 45 can be determined using any of the equations in Table 2 below.

TABLE 2

| Equation | Selected coordinate pair |
|---|---|
| I11 < I12 and I21 > I22 | (P_{c}, P_{d}) |
| I11 > I12 and I21 < I22 | (Pₐ, P_{b}) |
| I11 < I12 and I21 = I22 | (P_{c}, P_{d}) |
| I11 = I12 and I21 > I22 | (P_{c}, P_{d}) |
| I11 > I12 and I21 = I22 | (Pₐ, P_{b}) |
| I11 = I12 and I21 < I22 | (Pₐ, P_{b}) |

The present invention can be embodied as an optical touch screen, which can use the optical feature of image or mirror image information to select an actual coordinate pair of plural objects from a plurality of candidate coordinates. The coordinate determination method disclosed in the present invention can be applied directly to single touch technologies to avoid developing complex multi-touch technologies. Further, the coordinate determination method disclosed in the present invention is simple, and can quickly and efficiently calculate the coordinates of multiple touch points.

The above-described embodiments of the present invention are intended to be illustrative only. Numerous alternative embodiments may be devised by persons skilled in the art without departing from the scope of the following claims.

What is claimed is:

1. An optical touch screen system comprising:
a sensing device comprising a first sensor and a second sensor, the first sensor being configured to generate a first image from a first object and a second object, the second sensor being configured to generate a second image from the first object and the second object, the first image including a first image information and a second image information, and the second image including a third image information and a fourth image information; and
a processing unit taking into consideration of an intensity level or an area of the first image information, the second image information, the third image information, and the fourth image information to determine a first coordinate of the first object from the first image information and the third image information and a second coordinate of the second object from the second image information and the fourth image information.

2. The optical touch screen system of claim 1, wherein the area of the first image information is larger than the area of the second image information, and the area of the fourth image information is larger than the area of the third image information.

3. The optical touch screen system of claim 1, wherein the intensity level of the first image information is larger than the intensity level of the second image information, and the intensity level of the fourth image information is larger than the intensity level of the third image information.

4. The optical touch screen system of claim 1, wherein the first image information, the second image information, the third image information, and the fourth image informations are dark image informations created by the first object and the second object blocking the light incident on the first sensor and the second sensor or reflective informations on the first image and the second image created by the first object and the second object reflecting the light.

5. The optical touch screen system of claim 4, wherein the optical touch screen system is configured to allow the first object and the second object to block the light incident toward the first sensor and the second sensor so that the intensity level of the dark image informations are lower than that of a background of the first image and the second image.

6. The optical touch screen system of claim 4, wherein the optical touch screen system is configured to project the light onto the first object and the second object and allow the first object and the second object to reflect the light to the first sensor and the second sensor so that the intensity level of the reflective informations are higher than a background of the first image and the second image.

7. The optical touch screen system of claim 1, wherein the processing unit is configured to compute a plurality of viewing lines from the first image information, the second image information, the third image information and the fourth image information and using a position of the sensor as an starting point.

8. The optical touch screen system of claim 7, wherein the processing unit is configured to compute two viewing lines touching two side edges of the first object and an average of the two viewing lines.
